(19) United States
(12) Patent Application Publication
(10) Pub. No.: US 2019/0234708 A1
(43) Pub. Date: Aug. 1, 2019

(54) GUN HOLSTER SYSTEM AND METHOD OF MAKING THE SAME

(71) Applicants: James Myers, Abilene, TX (US); Charles Byrd, Abilene, TX (US); William T. Tucker, Abilene, TX (US)

(72) Inventors: James Myers, Abilene, TX (US); Charles Byrd, Abilene, TX (US); William T. Tucker, Abilene, TX (US)

(21) Appl. No.: 16/258,646

(22) Filed: Jan. 27, 2019

Related U.S. Application Data
(60) Provisional application No. 62/622,892, filed on Jan. 27, 2018.

(51) Int. Cl. F41C 33/02; B32B 9/02; B32B 9/04; B32B 7/09

(52) U.S. Cl. CPC F41C 33/0209; B32B 9/025; B32B 2250/03; B32B 7/09; B32B 9/045

(57) ABSTRACT

A holster includes a holster body formed by a polymer material and having with an exterior surface and an interior surface; the interior surface being composed of a soft material; the exterior surface being composed of the soft material; the interior surface and the exterior surface fully enclose the polymer material.

### BACKGROUND

### 1. Field of the Invention

The present invention relates generally to gun holsters.

### 2. Description of Related Art

Gun holsters are well known in the art and are effective means to carry a firearm. For example, FIG. 1 is a front view of a conventional gun holster 101 having a body 103 forming an opening configured to receive a pistol 105 therein. A strap 107 is integrally attached to the body 103 at one end and configured to hold the pistol 105 in place within the body 103.

One of the common problems associated with holster 101 is the damage to the pistol. For example, it is common for holsters to be composed of a hard, polymer material. This polymer material can easily be formed to receive the pistol securely, however, such material easily scratches and therefore damages the pistol. In addition, the removal and re-holstering of the pistol within the hard, polymer material is difficult to silence or be discrete with.

Accordingly, although great strides have been made in the area of gun holsters, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a front view of a conventional gun holsters;

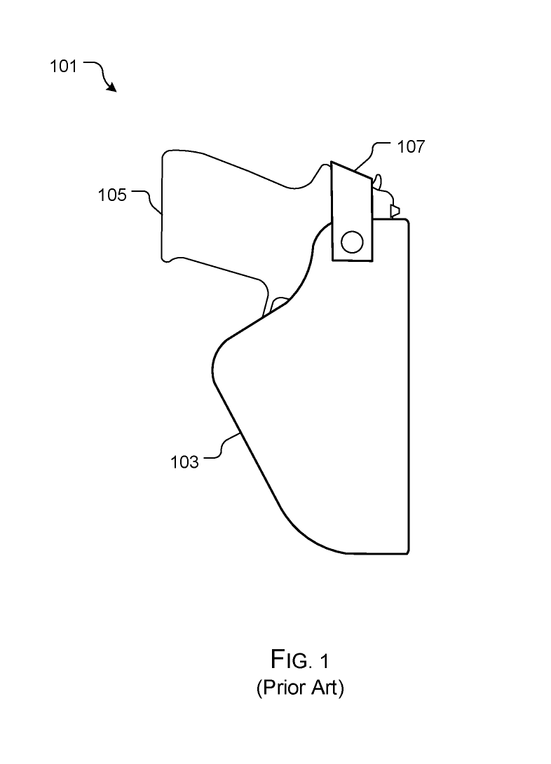

FIG. 2 is front view of a gun holster system in accordance with a preferred embodiment of the present invention;

FIG. 3 is a front view of a portion of an interior of the gun holster system of FIG. 2;

FIG. 4 is a front view of a portion of the interior of the gun holster system of FIG. 2 with the various layers partially removed for clarity; and

FIG. 5 is a flowchart of the method of making the gun holster system of FIG. 2.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional gun holster systems. Specifically, the present invention provides a means to protect a gun as it is holstered and removed from the holster. In addition, the present invention provides a means to quite the removal and re-holstering of a pistol within a holster. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

Referring now to the drawings wherein like reference characters identify corresponding or similar elements throughout the several views, the figures depict various views of a gun holster system 201 and method of use in accordance with a preferred embodiment of the present application. It will be appreciated that the gun holster system 201 overcomes one or more of the above-listed problems commonly associated with the conventional gun holsters.

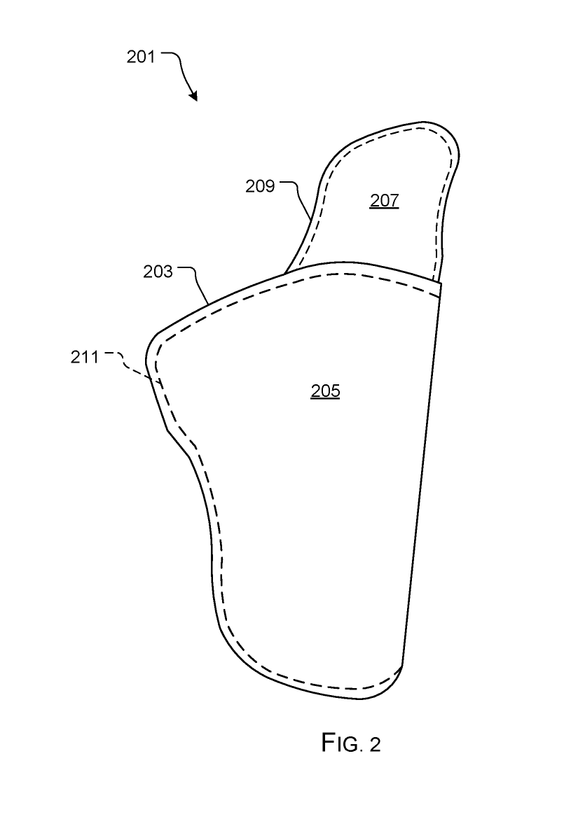

In FIG. 2, a front view of system 201 is shown having a body 203 configured to receive a pistol (not shown). The body 203 has an exterior surface 205 and an interior surface 207, wherein the interior surface 207 is created by a soft material, such as leather, thereby providing a means to protect the pistol as it is removed and replaced into the holster body 203. It should be appreciated that system 201 can include additional features, such as protrusions 209, straps, and the like.

In some embodiments, the exterior surface 205 is created via a leather material, however, other embodiments contemplate use of other flexible materials. Not shown in FIG. 2, is a layer of a polymer material, the polymer material being encompassed between the exterior and interior layers. In the preferred embodiment, stitching 211 is used to encompass the polymer material between the interior surface and the exterior surface such that the polymer layer does not show.

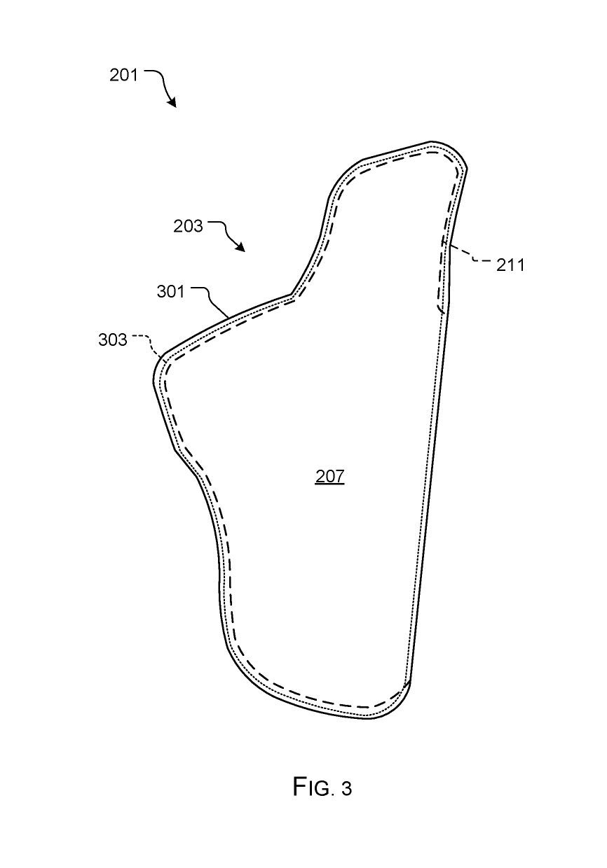

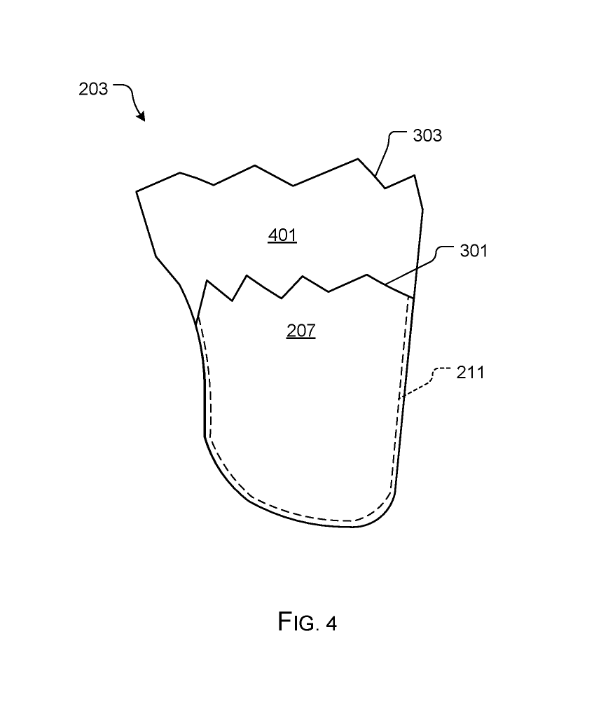

In FIGS. 3 and 4, a front view of an interior of a portion of body 203 is shown. In the preferred embodiment, a material 301, such as leather, is stitched 211 over the top of a polymer material 303, the polymer material 303 having a hard-exterior surface 401, and the material 301 fully covering the polymer material to form a soft surface 207. Surface 207 protecting the pistol during removal and re-holstering. In some embodiments, material 301 is stitched to the exterior material 403, thereby fully encompassing the polymer material 303.

One of the unique features believed characteristic of the present application is the use of a sewing/stitching technique to secure the interior layer (preferably composed of a leather, or similar synthetic material) over the polymer layer. It should be appreciated that this method provides a means to receive the benefit of using a polymer material, which is the securement of the pistol, with the benefit of protection afforded by the interior layer.

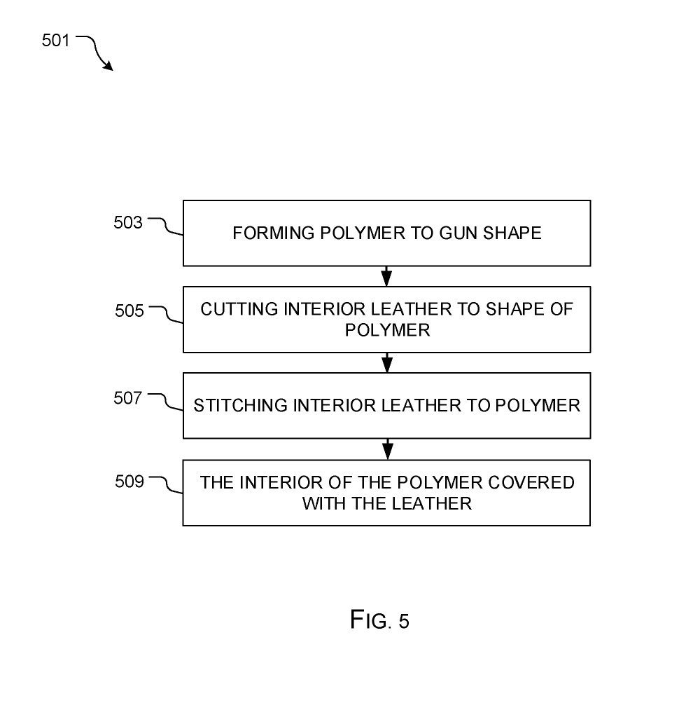

In FIG. 5, a flowchart 501 depicts a method of making the holster system of the present invention. A polymer material is formed to the appropriate shape of a gun, using conventional methods, as shown with box 503. The exterior and interior materials are then cut to the appropriate sizes and dimensions to fit around the polymer material, as shown with box 505. The three layers are then secured together via stitching/sewing, wherein the polymer material is secured between the two exterior leather (or similar material) layers, as shown with boxes 507, 509.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A holster, comprising:
a holster body formed by a polymer material and having with an exterior surface and an interior surface;
the interior surface being composed of a soft material;
the exterior surface being composed of the soft material;
wherein the interior surface and the exterior surface fully enclose the polymer material.

2. The holster of claim 1, wherein the soft material is leather.

3. The holster of claim 1, wherein the interior surface, polymer material, and exterior surface are stitched together.

4. A method of making a gun holster, the method comprising:
forming a polymer to a gun shape to create a body of the gun holster;
cutting an interior material to the gun shape;
cutting an exterior material to the gun shape; and
stitching the interior material, exterior material, and the polymer together such that he polymer will not come into contact with a gun being inserted and removed from the gun holster.
